(19) United States
(12) Patent Application Publication
(10) Pub. No.: US 2025/0260998 A1
(43) Pub. Date: Aug. 14, 2025

(54) ENHANCING USER DEVICE LOCATION INFORMATION BASED ON ACCESS POINT INFORMATION

(71) Applicant: QUALCOMM Incorporated, San Diego, CA (US)

(72) Inventors: Avinash SHRIVASTAVA, Hyderabad (IN); Gurdarshan SINGH, Pleasanton, CA (US); Wei CHEN, San Diego, CA (US)

(21) Appl. No.: 18/439,608

(22) Filed: Feb. 12, 2024

(51) Int. Cl. H04W 16/18; H04W 64/00

(52) U.S. Cl. CPC H04W 16/18; H04W 64/00

(57) ABSTRACT

An example method executed by a user device to provide access point information can include obtaining, by the user device from an access point, geospatial information of the access point. The method can further include assigning an identification (ID) tag to the access point, and transmitting, to a server, at least the geospatial information of the access point and the ID tag assigned to the access point by the user device. In an example implementation, the server may include the geospatial information of the access point and the ID tag assigned to the access point, in a database containing information about one or more access points. In an example implementation, the server may create a coverage map based on the information received from the user device and such information received from one or more other user devices.

### BACKGROUND

### 1. Field of Disclosure

The present disclosure relates generally to the field of position determination, and more specifically relates to determining a position of a user device with greater resolution.

### 2. Description of Related Art

Determining a location of a user device such as, for example, a laptop computer or a mobile phone, can be carried out in various ways. In some scenarios, the location information of the user device may be used for purposes such as navigation. In some other scenarios, the location information of the user device may be used by an entity for purposes such as to track/locate a user of the user device or to track/locate the user device after the user device has been stolen. The nature of the location information obtained and used in these two example scenarios can be different in view of different purposes of use of the location information.

### BRIEF SUMMARY

An example method executed by a user device to provide access point information can include obtaining, by the user device from an access point, geospatial information of the access point. The method can further include assigning an identification (ID) tag to the access point and transmitting, to a server, at least the geospatial information of the access point and the ID tag assigned to the access point by the user device.

An example method executed by a server to provide access point information can include receiving, from a first user device, geospatial information of a first access point and a first identification (ID) tag assigned to the first access point by the first user device. The method can further include creating a coverage map of access points located in a geographical area, the coverage map comprising the geospatial information of the first access point and the first ID tag assigned to the first access point and storing the coverage map in a database of the server.

An example user device that provides access point information can include a location determination system comprising at least one memory and one or more processors communicatively coupled with the at least one memory. The one or more processors are configured to obtain from a first access point, geospatial information of the first access point; assign a first identification (ID) tag to the first access point; and transmit to a server, at least the geospatial information of the first access point and the first ID tag assigned to the first access point by the one or more processors of the user device.

An example server that provides access point information can include a location determination system comprising at least one memory and one or more processors communicatively coupled with the at least one memory. The one or more processors configured to receive from a first user device, geospatial information of a first access point and a first identification (ID) tag assigned to the first access point by the first user device; create a coverage map of access points located in a geographical area, the coverage map comprising the geospatial information of the first access point and the first ID tag assigned to the first access point; and store the coverage map in a database of the server.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The detailed description below pertains to a few example embodiments that are illustrated in the accompanying drawings. However, it must be understood that the description is equally relevant to various other variations of the embodiments described herein. Such embodiments may utilize objects and/or components other than those illustrated in the drawings. It must also be understood that like reference numerals used in the various figures indicate similar or identical objects.

FIG. 1 shows an example system that includes a user device having a location determination system in accordance with the disclosure.

FIG. 2 illustrates an example scenario where the user device cooperates with an access point to provide information to a location server in accordance with the disclosure.

FIG. 3 shows an example geospatial information request that may be transmitted by a user device to an access point in accordance with an embodiment of the disclosure.

FIG. 4 shows some example information that can be provided by the access point to the user device in response to the geospatial information request illustrated in FIG. 3.

FIG. 5 shows another example geospatial information request that may be transmitted by a user device to an access point in accordance with an embodiment of the disclosure.

FIG. 6 shows some example information that can be provided by the access point to the user device in response to the geospatial information request illustrated in FIG. 5.

FIG. 7 shows a sequence diagram that illustrates various interactions between an access point and a user device in accordance with disclosure.

FIG. 8 illustrates the concept of augmented location information that may be generated and used for various purposes in accordance with the disclosure.

FIG. 9 illustrates an example database that can include augmented location information pertaining to multiple access points.

FIG. 10 shows a flowchart of a method performed by a user device for providing access point information to a server in accordance with an embodiment of the disclosure.

FIG. 11 shows a flowchart of a method performed by a location server to offer access point information in accordance with an embodiment of the disclosure.

FIG. 12 shows a block diagram of various hardware components of a user device according to an embodiment.

FIG. 13 shows a block diagram of various hardware components of a location server according to an embodiment.

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, particular features, structures, or characteristics described herein may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the phrase “user device” is not intended to be exclusive or limited to any specific implementation described herein, unless otherwise noted. In general, the phrase “user device” refers to any device that can perform location determination operations and can communicate with other devices such as, for example, an access point device and a server. Some non-exhaustive examples of a user device in accordance with disclosure can include a smartphone, a mobile phone, a tablet computer, a laptop computer, a wearable device (e.g., smartwatch, glasses, Augmented Reality (AR)/Virtual Reality (VR) headset, etc.), and an Internet of Things (IoT) device. It must be understood that references made with reference to a “location server” are equally applicable to any of various device implementations in accordance with the disclosure.

It must be understood that the word “augmenting” as used herein encompasses various alternative words in the spirit of the disclosure, such as, for example, “enhancing,” “improving,” and “enriching.” Words and phrases such as “satellites” or “space vehicle” (SV) as referred to herein, relates to an object that is capable of transmitting signals to receivers on the earth's surface. In one particular example, such an SV may be a geostationary satellite. Alternatively, an SV may be a satellite traveling in an orbit and moving relative to a stationary position on the earth. However, these are merely examples of SVs and claimed subject matter is not limited in these respects.

As described herein, a user device may determine location information of the user device based on signals received from one or more global navigation satellite system (GNSS) satellite vehicles (SVs). Location information determined by the user device based on GNSS signals received by the GNSS receiver may be referred to herein as a location estimate, a location fix, a fix, a position, a position estimate or a position fix. In some cases, a location may be described in a geodetic format, thus providing location coordinates for the global positioning system (GPS) receiver (e.g., latitude and longitude) which may or may not include an altitude component (e.g., height above sea level, height above or depth below ground level, floor level or basement level). In some other cases, the location information can include an altitude component such as, for example, when the user device is a navigation aid located in an airborne vehicle. A user device may also determine location information of the user device based on signals and/or data received from other sources in the manner described below.

The location information determined by a user device may be used in various ways. In one example scenario, the location information may be used by a user of the user device for purposes such as navigation. In another example scenario, the location information of the user device may be used by an entity other than the user of the user device, for various other purposes such as, for example, to locate the user of the user device or to track/locate the user device after the user device has been stolen. The nature of the location information obtained and used in these two example scenarios can be different in view of different purposes of use of the location information.

One example technical problem involves the use of the location information of a user device (such as a smartphone, for example) to locate the user of the smartphone. In an example scenario, the user may have used the smartphone to call an emergency services operator when faced with a situation such as, for example, being attacked inside a shopping mall. In this example scenario, a receiving equipment of the emergency services operator may receive the call and may determine an address of the shopping mall based on GPS location coordinates transmitted by the smartphone to the receiving equipment or based on performing a location determination procedure using multiple cellular communication towers. The address of the mall may then be displayed upon a display screen of the receiving equipment. The emergency services operator may dispatch an emergency services responder (police officer, medic, fireman, etc.) by providing to the emergency services responder, the address of the shopping mall displayed on the display screen. However, the information provided to the emergency services responder in the form of the mall address may be insufficient for the emergency services responder to determine which entrance of the shopping mall or which side of the shopping mall would be optimal to reach the user. Furthermore, the information provided to the emergency services responder in the form of the mall address may also be insufficient for the emergency services responder to determine which floor of the shopping mall to go to in order to reach the user. As a result, precious time may be lost in locating the user who is seeking help.

In another example scenario, the user may have used the smartphone to call an emergency services operator when faced with a situation such as, for example, being robbed in a parking lot of the shopping mall described above. In this example scenario, the information provided to the emergency services responder in the form of the mall address may be insufficient for the emergency services responder to determine which side of the shopping mall is closest to where the user is located in the parking lot. As a result, precious time may be lost in locating the user who is seeking help.

Accordingly, a technical solution to address the technical problem described above is provided herein. More particularly, in accordance with an embodiment of the disclosure, a location server may augment location information of a user device with geospatial information and/or identification (ID) information of an access point (AP) to which the user device is communicatively attached so as to determine a precise location of the user device and/or of the AP.

In the example scenario described above with reference to a user located inside a shopping mall, the emergency services operator may be able to obtain the augmented location information from the location server and direct an emergency services responder to a more precise location of the user. For example, the augmented location information may enable the emergency services provider to direct the emergency services responder to go to a specific floor of the shopping mall. The specific floor may be identifiable based on the location information and/or identification (ID) information of the AP.

Generating and using augmented location information in accordance with the disclosure offers various advantages over conventional solutions by enabling quicker and more precise locating of a user device. In an example scenario, the user device can be a smartphone carried by an individual who may be seeking help from an E911 operator. In such a scenario it would be advantageous to obtain a detailed and precise location of the individual that is automatically generated by the user device and a location server device, in contrast to a conventional approach that can involve obtaining oral information provided by the individual by speaking into the smartphone. The oral information may be less than optimal because it can depend on a capability of the individual to convey information in a stressful situation.

Another example technical problem involves keeping track of one or more APs and obtaining up-to-date information about APs. Accordingly, a technical solution to address this problem can involve a location server storing geospatial information of an AP in a database and updating the database if the AP is moved from one location to another. In another example implementation, the location server may store the geospatial information of multiple APs and update the database when any of the multiple APs are moved from one location to another. The geospatial information of multiple APs may be stored in the database in the form of a coverage map that may be used in various ways by various entities.

In another example implementation, the location server can utilize the geospatial information of multiple APs stored in the database to locate one or more user devices when, for example, a user device communicatively attaches to a first AP and/or when the user device communicatively attaches to a first AP followed by communicatively attaching to a second AP when the user device moves from a first location at which the first AP is located to a second location at which the second AP is located. In an example embodiment, the location server can utilize the geospatial information of multiple APs as a part of a tracking procedure to track a user device and/or to create one or more travel routes for other user devices.

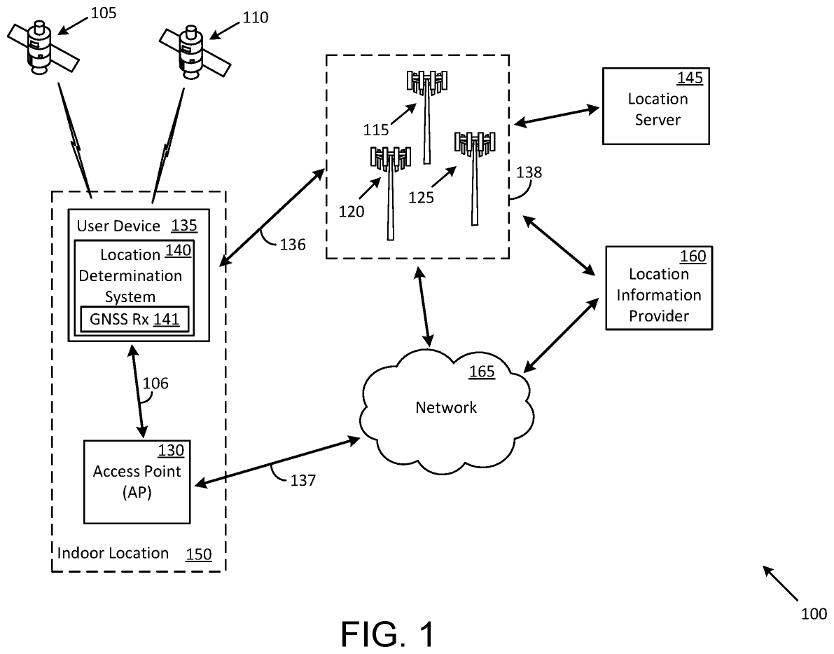

FIG. 1 shows an example system 100 that includes a user device 135 having a location determination system 140 in accordance with the disclosure. Some non-exhaustive examples of the user device 135 in accordance with disclosure can include a smartphone, a mobile phone, a tablet computer, a laptop computer, a wearable device (e.g., smartwatch, glasses, AR/VR) headset, etc.), and an Internet of Things (IoT) device. In the illustrated example system 100, the user device 135 is located in an indoor location 150, which can be, for example, a building (residence, office, commercial establishment, public building, etc.). In another scenario, the user device 135 can be located outside the indoor location 150 such as, for example, when the user device is a smartphone carried by a person located outside in an open-air environment. Other devices that can be located in the indoor location 150 can include an access point (AP) 130 that is configured to support wireless communications between the AP 130 and the user device 135. In the illustrated example, the user device 135 may communicate with the AP 130 via a communications link 106 that can support wireless communications in a WiFi communications format (2.4 GHz WiFi, 5 GHz WiFi, 6 GHZ WiFi, for example). In another implementation, the communications link 106 can support wireless communications in various other communications formats such as, for example, ultra-wide band (UWB), Bluetooth®, infrared, near field communication (NFC), ultraband and Zigbee®.

The AP 130 is typically a device that acts as a bridge between wireless-capable devices (such as, the user device 135), and a wired network infrastructure such as, for example, a local area network (LAN) or a wide-area network. In the example system 100, the AP 130 is communicatively coupled to a network 165 via a communication link 137. In an example implementation, the network 165 is the Internet and the communication link 137 can be, for example, a fiberoptic communication link, a coaxial communication link, or a wireless communication link, configured to support communications in one or more of various communication formats and protocols, such as, for example, Transport Control Protocol/Internet Protocol (TCP/IP).

The location determination system 140 of the user device 135 can include components having hardware, software, and/or firmware configured for executing various actions in accordance with disclosure. One of the components of the location determination system 140 can be a GNSS receiver 141 that is configured to receive signals from one or more GNSS satellite vehicles (SVs). The signals can be operated upon by a processor (not shown) of the location determination system 140 to determine a location of the user device 135. The location of the user device 135 may be defined in the form of location coordinates (GPS location coordinates, for example).

In the illustrated example, the GNSS receiver 141 can include an antenna that is arranged to receive GNSS signals from one or both of a first SV 105 and a second SV 110. In some cases, two separate antennas can be used for receiving GNSS signals, such as, for example, a first antenna tuned to receive GNSS signals from the first SV 105 (which could belong to a GPS satellite system) and a second antenna tuned to receive GNSS signals from the second SV 110 (which could belong to a GLONASS system).

It will be understood that the diagram provided in FIG. 1 is greatly simplified. In practice, there may be dozens of satellites in a GNSS system, and there are many different types of GNSS systems. Some examples of GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to a basic positioning functionality that provides a certain degree of accuracy, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

A GNSS positioning procedure is typically based on trilateration/multilateration, which is a method of determining position by measuring distances to points at known coordinates. In general, the determination of the position of the user device 135 by use of the GNSS receiver 141, in three dimensions, may rely on a determination of the distance between the GNSS receiver 141 and four or more satellite vehicles. Three-dimensional (3D) coordinates may be based on a coordinate system (e.g., XYZ coordinates; latitude, longitude, and altitude; etc.) centered at the earth's center of mass. A distance between each satellite vehicle and the GNSS receiver 141 may be determined using precise measurements made by the GNSS receiver 141 of a difference in time from when a RF signal is transmitted from the respective satellite vehicle to when it is received at the GNSS receiver 141. To help ensure accuracy, not only does the GNSS receiver 141 need to make an accurate determination of when the respective signal from each satellite vehicle is received, but many additional factors need to be considered and accounted for. These factors include, for example, clock differences at the GNSS receiver 141 and satellite vehicle (e.g., clock bias), a precise location of each satellite vehicle at the time of transmission (e.g., as determined by the broadcast ephemeris), the impact of atmospheric distortion (e.g., ionospheric and tropospheric delays), and the like.

To perform a traditional GNSS position fix, the GNSS receiver 141 can use code-based positioning to determine its distance to each satellite vehicle based on a determined delay in a generated pseudorandom binary sequence received in the RF signals received from each satellite, in consideration of the additional factors and error sources previously noted. With the distance and location information of the satellite vehicles, the GNSS receiver 141 can then determine a position fix for its location. This position fix may be determined, for example, by a Standalone Positioning Engine (SPE) executed by one or more processors of the GNSS receiver 141. However, code-based positioning is relatively inaccurate and, without error correction, is subject to errors. Even so, code-based GNSS positioning can provide a positioning accuracy for the GNSS receiver 141 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellite vehicles observed by the GNSS receiver 141 can be mitigated or canceled based on similar carrier-based ranging of the satellite vehicles using a highly accurate GNSS receiver at the base station at a known location. These measurements and the base station's location can be provided to the GNSS receiver 141 for error correction. This position fix may be determined, for example, by a Precise Positioning Engine (PPE) executed by one or more processors of the GNSS receiver 141. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters). (An SPE and/or PPE may be referred to herein as a GNSS positioning engine, and may be incorporated into a broader positioning engine that uses other (non-GNSS) positioning sources.)

Multiple satellite bands are allocated to satellite usage. These bands include the L-band, the C-band, the X-band, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

Multi-frequency GNSS receivers use satellite signals from different GNSS frequency bands (also referred to herein simply as “GNSS bands”) to determine desired information such as pseudoranges, position estimates, and/or time. One or more of the satellite vehicles may transmit multiple satellite signals in different GNSS frequency bands, such as, for example, L1, L2, and L5 frequency bands. The terms L1 band, L2 band, and L5 band are used herein because these terms are used for GPS to refer to respective ranges of frequencies. Various receiver configurations may be used to receive satellite signals. For example, the GNSS receiver 141 may use separate receive chains for different frequency bands. As another example, the GNSS receiver 141 may use a common receive chain for multiple frequency bands that are close in frequency, for example L2 and L5 bands. As another example, the GNSS receiver 141 may use separate receive chains for different signals in the same band, for example GPS L1 and GLONASS L1 sub-bands. A single receiver may use a combination of two or more of these examples. These configurations are examples, and other configurations are possible.

Location determination of the user device 135 by use of GNSS signals in the manner described above may, or may not, be feasible due to various factors. In an example scenario, the user device 135 may be located in a place where GNSS signals are not receivable, such as, for example, in an intermediate floor of a multi-story shopping complex or in an underground parking lot. The location determination system 140 may therefore be configured to obtain location information of the user device 135 in multiple ways.

In an example implementation, the location determination system 140 can be further configured to determine a location of the user device 135 by performing a multilateration procedure based on communications with multiple cellular communication towers. An example multilateration procedure that is typically referred to as a trilateration procedure, works on the general principle that a location of an object can be determined based on three individual distances between the object and three reference points (such as, for example, between a cell phone and three cell towers). FIG. 1 illustrates three cellular communication towers (a first cellular communication tower 115, a second cellular communication tower 120, and a third cellular communication tower 125 of a cellular network 138) that may be used by the location determination system 140 for performing a trilateration procedure. The communication link 136 can be configured for cellular communications such as, for example, 3G wireless communications, 5G wireless communications, and/or Long-Term Evolution (LTE) communications.

The trilateration procedure can involve, for example, a time of flight (TOF) measurement or a time delay-to-distance conversion measurement that is based on cellular signal communications. An example scenario where such a position determination procedure is typically employed is for providing E911 services. E911 services are directed at enhancing 911 services applicable to fixed-location devices (a land line telephone, for example).

In another example implementation, the location determination system 140 can be also configured to determine a location of the user device 135 based on communications with a server of a location information provider 160. The server, which can be cloud-based, can include a database containing location information such as, for example, one or more maps (Google maps®, for example) that are made accessible to the location determination system 140. The location information provided by the location information provider 160 may be used for various purposes such as, for example, to obtain location information of the user device 135 and/or to provide navigation assistance to a user of the user device 135.

In another example implementation, the location determination system 140 may determine a location of the user device 135 based on communications with short-range devices such as, for example, WiFi access points, UWBs, and Bluetooth devices. WiFi devices, ultra-wide band (UWB) devices, Bluetooth® devices, infrared devices, near field communication (NFC) devices, and Zigbee® devices.

In an example procedure performed in accordance with the disclosure, the location determination system 140 can communicate with the AP 130 to obtain geospatial information of the AP 130 and can provide the geospatial information of the AP 130 to a location server 145 together with location information of the user device 135 that is determined by the location determination system 140 in any one or more of the ways described above. The location server 145, which can be cloud-based, determines a location of the user device 135 in an enhanced manner by augmenting the location information generation generated by the location determination system 140 with the geospatial information of the AP 130.

In an example implementation, the user device 135 can be operable by use of an operating system (OS) such as, for example, an Android OS or any other type of third-party OS, and the location determination system 140 can be configured to authenticate the geospatial information of the AP 130 in accordance with the disclosure by using techniques that can include, for example, device-based hybrid (DBH) positioning techniques and/or coarse time positioning techniques.

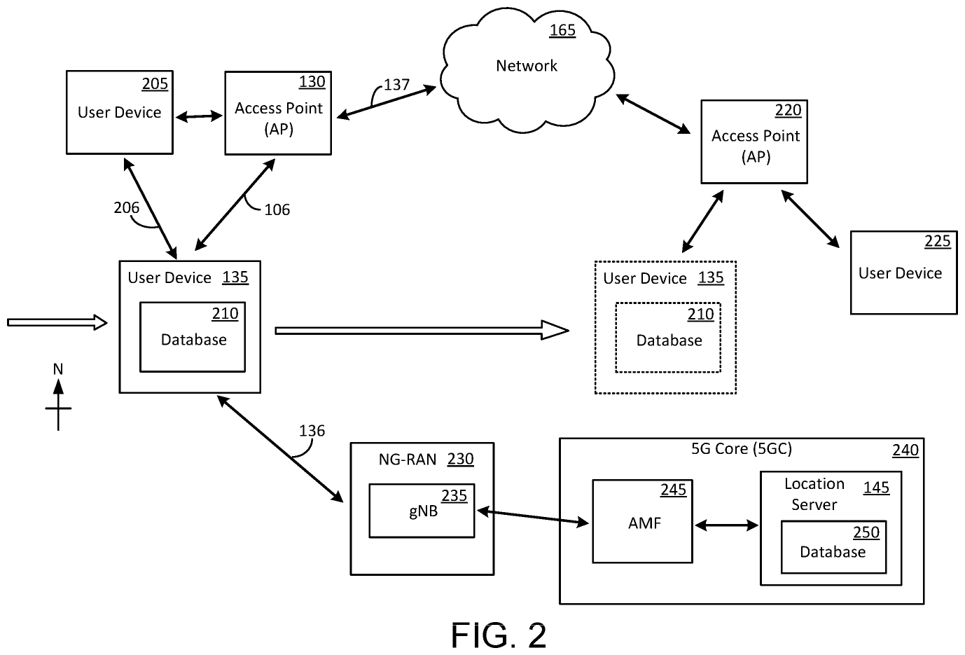

FIG. 2 illustrates an example scenario where the user device 135 cooperates with the AP 130 to enable the location server 145 to determine an augmented location of the user device 135 and/or to assist the location server 145 create a coverage map that includes information about one or more access points in accordance with the disclosure.

In this example implementation, the user device 135 can communicate with the location server 145 via a cellular network, such as the cellular network 138 illustrated in FIG. 1. The cellular network 138 can be any of various types of networks such as, for example, a 3G network, a Long Term Evolution (LTE) network, or a 5G network. In this example implementation, the location determination system 140 of the user device 135 can communicate with the location server 145 via a general Node B (gNodeB, gNB) of a Next Generation Radio Access Network (NG-RAN) 230 that is a part of a 5G network and an Access and Mobility Management Function (AMF) 245 of a 5G Core (5GC) 240 that is also a part of the 5G network. The gNB 235 may be alternatively referred to as a base station or a RAN node. Other functional elements of the NG-RAN 230 and the 5G Core 240 are not illustrated in FIG. 2 but can be understood by persons skilled in the art pertaining to cellular networks.

Implementations described herein (be they for 5G technology and/or for one or more other communication technologies and/or protocols) may be used for various purposes such as to provide location assistance to the user device 135, to compute a location of the user device 135, and/or to augment location information of the user device 135 with geospatial information and/or identification (ID) information of the AP 130 to which the user device 135 is communicatively attached.

A node/system that implements the location server 145 may additionally or alternatively, implement various types of location-support modules, such as, for example, an Enhanced Serving Mobile Location Center (E-SMLC) or a Secure User Plane Location (SUPL) Location Platform (SLP). At least a part of a positioning functionality described herein may be performed by the user device 135 (e.g., using signal measurements obtained by the user device 135 from signals transmitted to the user device 135 by wireless nodes such as the gNB 235 and/or assistance data provided to the user device 135 by the location server 145). At least a part of the positioning functionality may alternatively be performed by the location server 145 (e.g., using signal measurements obtained by one or more gNBs).

The location server 145 may communicate with the gNB 235 using a communication protocol such as, for example, a New Radio Position Protocol A (NRPPa) defined in 3GPP Technical Specification (TS) 38.455. The communications may be based on NRPPa messages transferred between the location server 145 and the gNB 235 via the AMF 245. The location server 145 may also communicate with the user device 135 using an LTE Positioning Protocol (LPP) as defined in 3GPP TS 37.355. The NRPPa protocol may be used to support positioning of the user device 135 by using network-based position methods such as E-CID (e.g., when used with measurements obtained by gNBs such as the gNB 235) and/or may be used by the location server 145 to obtain location related information from the gNB 235, such as parameters defining directional Synchronization Signal (SS) transmissions from the gNB 235.

The location server 145 is illustrated in FIG. 2 as being located in the 5G core 240, but in other implementations, the location server 145 may be external to the 5G core 240 such as, for example, in the NG-RAN 230. As another example, the location server 145 may be co-located or integrated with the gNB 235 or may be disposed remote from the gNB 235 and configured to communicate directly or indirectly with the gNB 235.

In a first example position method, which can be referred to as a UE-assisted position method, the user device 135 may obtain location measurements and send the location measurements to the location server 145 for computation of a location estimate for the user device 135. The location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ), AOA, AOD, for the gNB 235 and/or the AP 130. The location measurements may further include measurements of GNSS pseudorange, code phase, and/or carrier phase for satellite vehicles such as the SV 105 and the SV 110.

In a second example position method, which can be referred to as a UE-based position method, the user device 135 may obtain location measurements (which may be the same as, or similar to, location measurements for a UE-assisted position method) and may compute a location of the user device 135 (for example, with the help of assistance data received from a location server such as the location server 145 or broadcast by gNBs such as the gNB 235).

The description above, which relates to 5G technology, is equally applicable to other communication technologies, such as, for example, GSM, WCDMA, and LTE that are used for supporting and interacting with various types of mobile devices such as the user device 135, to implement various functionalities such as, for example, related to voice and data. Accordingly, for example, in an Evolved Packet System (EPS), the NG-RAN 230 may be replaced by an E-UTRAN containing eNBs and the 5G core 240 may be replaced by an Evolved Packet Core (EPC) containing a Mobility Management Entity (MME) in place of the AMF 245 and a serving mobile location center (E-SMLC) in place of the location server 145.

An example procedure to determine an augmented location of the user device 135 can involve the location server 145 transmitting a request to the user device 135 (via the AMF 245 and the gNB 235) for location information. The request may be originated, for example, by the location server 145 in response to a query sent to the location server 145 by an emergency services provider who is seeking to locate a user of the user device 135. The user of the user device 135 in this example scenario may be located inside a multi-story building or in an underground parking lot and may be unable to convey to the emergency services provider, information that can assist the emergency services provider locate the user quickly and precisely.

The information provided by the user device 135 to the location server 145 can include a combination of location information of the user device 135 (GPS coordinates, map information, etc.), geospatial information of the AP 130 (third floor, north side of a mall, a mailing address, for example), and an identification tag that can be assigned by the user device 135 to the AP 130. The location information of the user device 135 can be generated by the user device 135 based on executing a location determination procedure that includes obtaining information from one or more of various sources in the manner described above (GNSS satellite vehicles, cellular communication towers, location information provider 160, etc.).

The geospatial information of the AP 130 that may be provided by the user device 135 to the location server 145 can be obtained by the user device 135 via communications with the AP 130. In an example implementation, the communications can include a request made by the user device 135 to the AP 130 (for example, in the form of a location configuration information (LCI) request) and a response provided by the AP 130 to the request (for example, in the form of an LCI report). The user device 135 can assign an identification tag to the AP 130 and/or to the geospatial information contained in the LCI report, and transmit to the location server 145, the identification tag along with the geospatial information to the location server 145. The ID tag can be any label that may be used for uniquely identifying the AP 130. One example of an ID tag can be a label such as, for example, a name assigned to the AP 130 by an individual associated with the AP 130 (user, manager, administrator, etc.) or a physical address in which the AP 130 is located (ABC company office, XYZ residence, etc.). Another example of an ID tag can be a wireless wide area network (WWAN) cell identification, an international mobile subscriber identity (IMSI) of the AP 130, an access point name (APN) of the AP 130, or a media access control (MAC) address of the AP 130.

In an example embodiment, the user device 135 can store information in a database 210 that can be a part of the user device 135. The information can include, for example, the location information of the user device 135, the geospatial information of the AP 130, the identification tag assigned to AP 130, and/or an identification tag assigned to the geospatial information of the AP 130. The information stored in the database 210 may be made available for use by one or more devices such as, for example, another user device that may use at least some of this information for purposes such as for determining a relative location of the user device with respect to the user device 135 and/or with respect to the AP 130.

In another example embodiment, the location server 145 can determine a location of the user device based on augmenting the location information generated and provided by the user device 135 with the geospatial information of the AP 130 and the ID tag assigned to the AP 130. The augmented location information can be made available for use by any of various entities such as, for example, an emergency services provider, in the manner described above.

In another example embodiment, the location server 145 can store information in a database 250 that can be a part of the location server 145. The information can include, for example, the geospatial information of the AP 130, the identification tag assigned to AP 130, an identification tag assigned to the geospatial information of the AP 130, and/or an augmented location address of the user device 135. The location server 145 may also obtain and store additional such information associated with one or more other access points in addition to the AP 130. In an example implementation, the information stored in the database 250 can be stored in the form of a coverage map that provides information about multiple access points that may be located inside a geographical area. The coverage map can be made available to any of various client devices such as, for example, one or more user devices.

In an example implementation, at least a portion of the information stored in the database 250 of the location server 145 can be stored in the database 210 of the user device 135. The portion of the information stored in the database 210 of the user device 135 can include, for example, information pertaining to the AP 130 and information pertaining to the AP 220. Furthermore, in an example implementation, a coverage map, which at least partially reflects the coverage map stored in the database 250 of the location server 145, can be created by the user device 135 and stored in the database 210 of the user device 135. The coverage map stored in the database 210 of the user device 135 may be made available to other devices upon request.

In an example operating scenario, a user device 205 may communicate with the user device 135 to obtain information stored in the database 210 of the user device 135, for example, in the form of a coverage map. The communications between the user device 205 and the user device 135 may be carried out via a communication link 206 using sidelink communications. Sidelink communications can be generally described as device-to-device (D2D) communications between devices. The user device 135 provides, to the user device 205, location information of the user device 135, which, in turn, can assist the user device 205 to determine a relative location of the user device 205 with respect to the user device 135 and/or with respect to the AP 130. In some cases, the user device 205 may be communicatively attached to the AP 130, while, in some other cases, the user device 205 may be communicatively attached to a different AP or not communicatively attached to any AP.

In another example operating scenario, the database 250 of the location server 145 can be configured to store geospatial information of the AP 130 together with a first identification tag assigned by the user device 135 to the geospatial information of the AP 130 and to also store geospatial information of another AP 220 together with a second identification tag assigned by another user device 225 to the geospatial information of the AP 220. The coverage map referred to above, which contains information associated with the AP 130, may be updated with the information about the AP 220. In this example, the AP 130 and the AP 220 are located in a geographical area that may be served by the location server 145.

In another example operating scenario, the user device 135 may be a mobile device, such as, for example, an IoT device attached to an object that is moving cast past the AP 130. In this scenario, the user device 135 may communicate with the location server 145 for providing information about one or more access points that may be encountered by the user device 135 when moving along a travel path. As a part of this procedure, the user device 135 may communicatively attach to the AP 130 (if authorized to do so, via use of an appropriate password or passcode, for example). The AP 130 can then obtain geospatial information from the AP 130 and assign an identification tag to the AP 130 and/or to the geospatial information obtained from the AP 130. The user device 135 can then convey the geospatial information and the identification tag to the location server 145 via the AP 130 and/or via the cellular network 138.

The location server 145 can evaluate the information provided by the user device 135 against information stored in the database 250 and can either store the information in the database 250 (if not stored previously) or update the information stored in the database 250. In an example case, the geospatial information and the identification tag associated with the AP 130 may already be present in the database 250, and the location server 145 may detect a change such as, for example, a change in a location address of the AP 130. If any such change is detected, the location server 145 can update the information in the database 250 and/or update a coverage map. Thus, the coverage map can be kept in an updated condition that reflects current information about the AP 130 and/or a current operational status of the AP 130.

The user device 135 may then move along the travel route and repeat the procedure described above, after communicatively attaching to the AP 220. In this case, information about the AP 220 that may be stored in the database 250 may have been previously provided to the location server 145 by the user device 225. The location server 145 can compare the information about the AP 220 that is provided by the user device 135 against the information previously provided by the user device 225 and either validate, or update, the coverage map based on the comparison. The coverage map may provide to other user devices, information about various access points in the geographical area, such as, for example, geospatial information, cell coverage information, cell ID information, international mobile subscriber identity (IMSI) information, APN information, and/or MAC address information.

In another operational scenario, the location server 145 may execute a tracking procedure to track the user device 135 based on the user device 135 attaching to various access points along the travel route of the user device 135. The tracking procedure enables the location server 145 to plan, and to create a travel route for a user device other than the user device 135. Planning the travel route can further include identifying an alternative segment of the travel route based on factors such as, for example, availability of access points along the alternative segment and support provided by the access points (accurate and up-to-date geospatial information, for example).

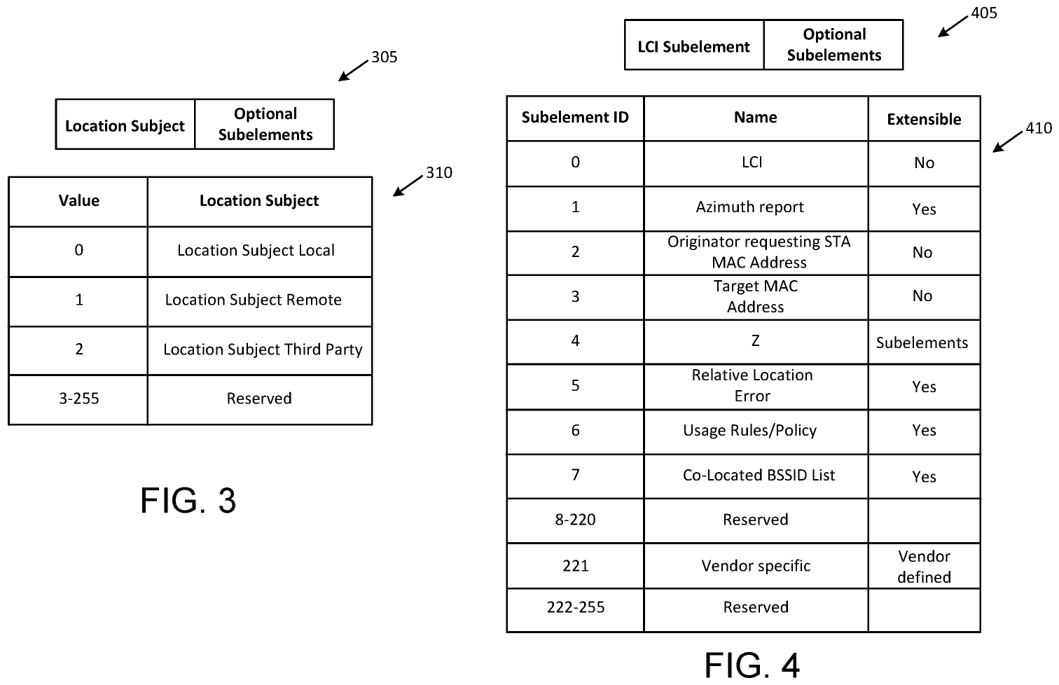

FIG. 3 shows an example geospatial information request that may be transmitted by the user device 135 to the AP 130 in accordance with an embodiment of the disclosure. The geospatial information request may be transmitted in any of various formats of wireless signals such as, for example, a WiFi signal or a Bluetooth® signal. The structure of this example geospatial information request can conform to a location configuration information (LCI) request 305 that is in accordance with IEEE 802.11. More particularly, as is known, the IEEE 802.11-2016 Wi-Fi standard introduced ranging estimation between two devices through the so-called fine time measurement (FTM) protocol, defined by the IEEE 802.11mc. IEEE 802.11mc is geared toward maintaining the IEEE 802.11 standard and related documentation and includes all IEEE 802.11 amendments and revisions applied to the IEEE 802.11 standard for wireless local area network services and compatible devices. Additional details pertaining to the location subject field that is a part of the LCI request 305 is shown in location subject field definition table 310.

FIG. 4 shows some example information that can be provided by the AP 130 to the user device 135 in response to the geospatial information request illustrated in FIG. 3. In this example, the information provided by the AP 130 to the user device 135 is in the form of a location configuration information (LCI) report 405 that is in accordance with IEEE 802.11, and more particularly in accordance with IEEE 802.11mc. Additional details pertaining to the LCI subelement field that is a part of the LCI report 405 is shown in the form of subelement IDs 410.

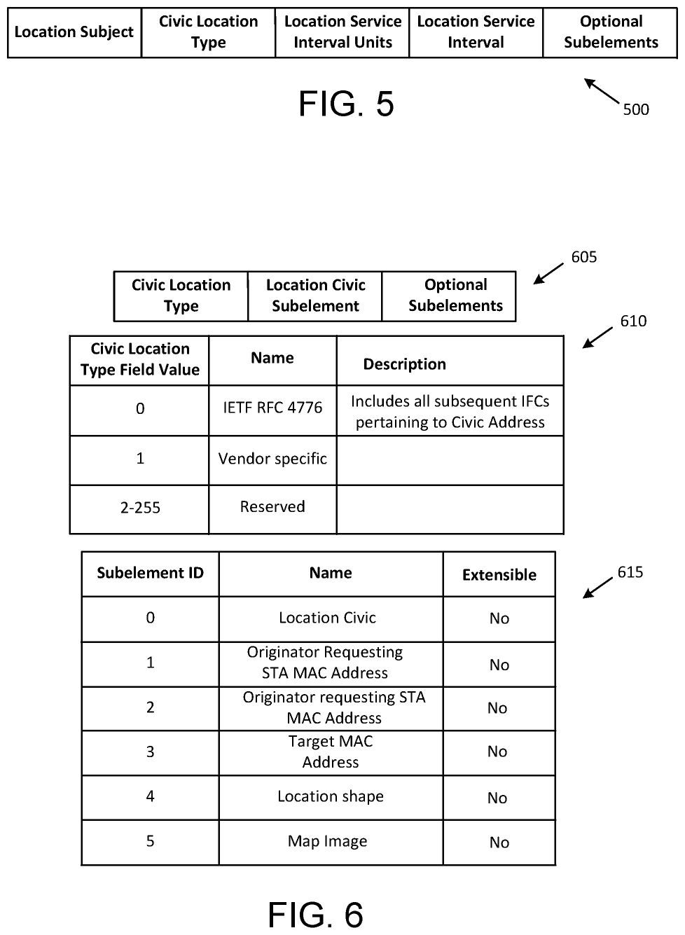

FIG. 5 shows another example geospatial information request that may be transmitted by the user device 135 to the AP 130 in accordance with an embodiment of the disclosure. The geospatial information request may be transmitted in any of various formats of wireless signals such as, for example, a WiFi signal or a Bluetooth® signal. The structure of this example geospatial information request can conform to a location civic request (LCR) 500 that is in accordance with IEEE 802.11, and more particularly in accordance with IEEE 802.11mc.

FIG. 6 shows some example information that can be provided by the AP 130 to the user device 135 in response to the geospatial information request illustrated in FIG. 5. In this example, the information provided by the AP 130 to the user device 135 is in the form of a location civic report 605 that is in accordance with IEEE 802.11, and more particularly in accordance with IEEE 802.11mc. Additional details pertaining to the civic location type field that is a part of the location civic report 605 is shown in the form of civic location type field values 610. One of the civic location field values (0) pertains to civic addresses specified in standards such as, for example, IETF RFC 4776. Such civic addresses can be used to as at least a part of the geospatial information referred to herein in this disclosure. Additional details pertaining to subelement IDs that is a part of the location civic report 605 is shown in the subelement IDs table 615.

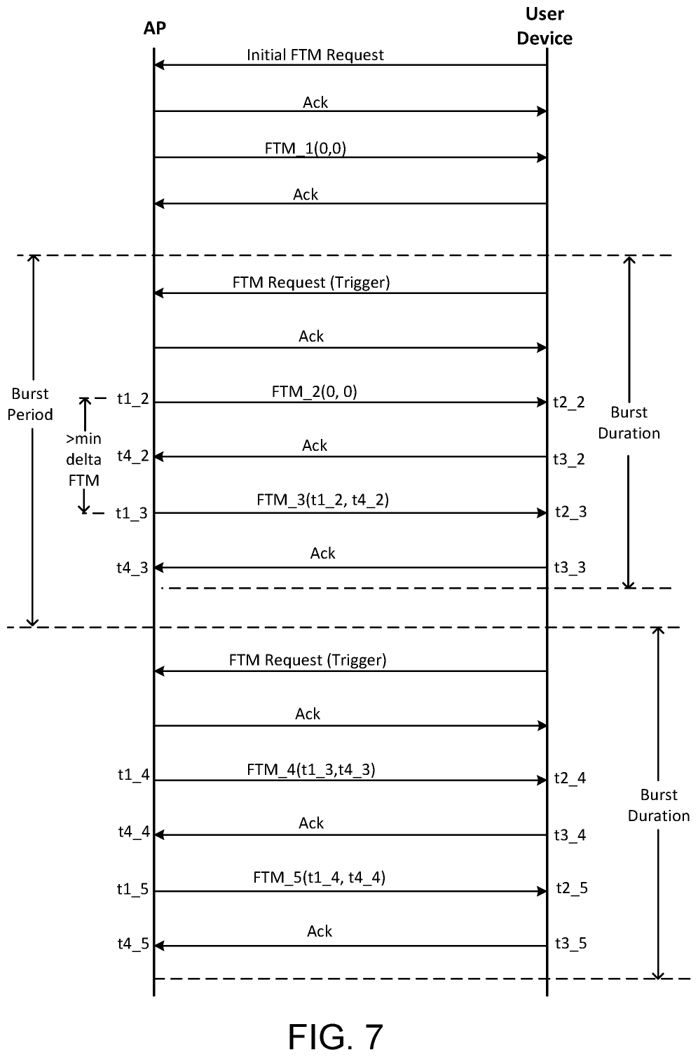

FIG. 7 shows a sequence diagram that illustrates various interactions between an access point (such as, for example, the AP 130) and a user device (such as, for example, the user device 135) in accordance with disclosure. The interactions in this example can be based on communications performed using the fine timing measurement (FTM) protocol that is in accordance with IEEE 802.11. The FTM protocol supports performing measurements such as, for example, a round-trip time (RTT) measurement, a time of arrival (TOA) measurement, and a time difference of arrival (TDoA) measurement between the AP 130 and the user device 135. More particularly, some of the FTM frames used in such measurements can be configured to support communications between the user device 135 and the AP 130 that enable the user device 135 to obtain geospatial information of the AP 130 in accordance with the disclosure. In an example implementation, the FTM frames can support communications in the manner described above with reference to FIGS. 3-6 (location configuration information (LCI) request 305, location configuration information (LCI) report 405, location civic request (LCR) 500, and location civic report 605). The user device 135 can be, for example, a mobile phone that includes an operating system that supports FTM-based RTT measurements. In some cases, the FTM protocol may be preferred over a Timing Measurement protocol for obtaining higher precision in location determination, particularly in indoor locations.

It must be understood that the description provided above with respect to FIGS. 3 through 7 represent one example implementation using communication formats supported by IEEE. In other implementations, the user device 135 may communicate with the AP 130 in other ways and other communication formats.

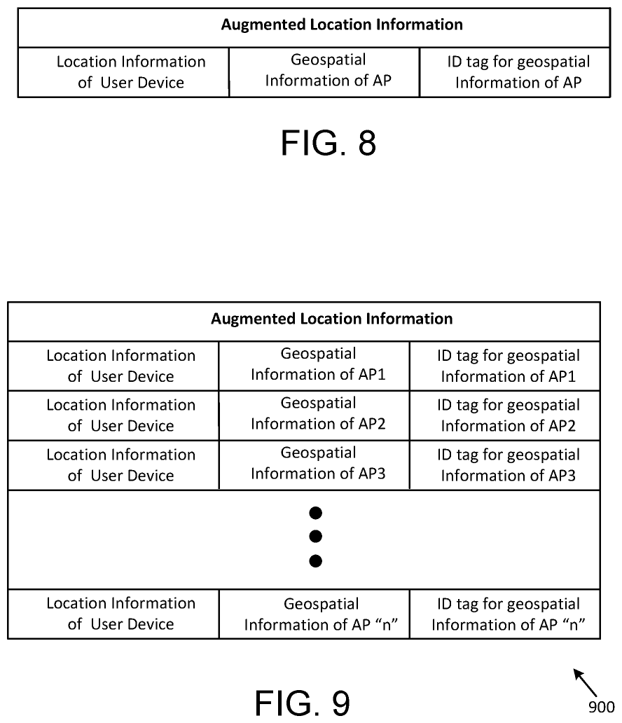

FIG. 8 illustrates the concept of augmented location information that may be generated and used for various purposes in accordance with the disclosure. The augmented location information can include, for example, location information of a user device, geospatial information of an access point, and an identification tag assigned to the geospatial information of an access point or to the access point.

Determining the location information of a user device has been described above with reference to user device 135, such as, for example, determining a location of the user device 135 based on GNSS signals received from one or both of the first SV 105 and the second SV 110, determining a location of the user device 135 based on performing a multilateration procedure using multiple cellular communication towers, and/or based on communications with a server of a location information provider 160 (Google maps®, for example). The format of the location information is generally dependent on the type of procedure used. For example, when the location of the user device 135 is based on GPS signals, the location information may be obtained in the form of GPS coordinates.

The location information obtained in the manner described above, may, in certain scenarios, prove inadequate for use. For example, in one example scenario, a user of the user device 135 may be located inside a shopping mall. Based on the location information obtained by the user device 135, the emergency services operator may be able to obtain an address of the shopping mall. Merely obtaining the address of the shopping mall may prove sub-optimal to locate the user of the user device 135 inside the shopping mall.

In this example scenario, augmenting the location information of the user device 135 with the geospatial information of the AP 130 to which the user device 135 is attached and/or the identification tag assigned to the geospatial information of the AP 130 may prove more optimal to locate the user of the user device 135 in a timely manner. The term “geospatial information” as used herein may be generally defined as including geographical information and spatial information, and in some cases, may further include temporal information as well as information about an object. More generally, geospatial information can be a combination of location information (usually coordinates on the earth), attribute information (the characteristics of the object), and temporal information (the time or life span at which the location and attributes exist).

As indicated above, merely obtaining the address of the shopping mall may prove sub-optimal and inadequate for use by the emergency services operator to locate the user of the user device 135 inside the shopping mall. In an example implementation, the augmented location information may be used to generate a three-dimensional (3D) rendering of at least a portion of the shopping mall. The 3D rendering may assist the emergency services operator to precisely identify the AP 130 as being located on the third floor of the shopping mall, for example, and that the user device 135 is located within WiFi range of the AP 130. Thus, the augmented location information may be used to locate the AP 130 and/or the user device 135 in accordance with the disclosure. More particularly, in this example implementation, the emergency services operator may be able to use the 3D rendering to direct an emergency services responder to reach a more precise location of the user, such as, for example, a specific floor of the shopping mall and/or to a specific address of a store on that floor.

In an example implementation in accordance with the disclosure, the location server 145 may store the augmented location information and/or the geospatial information of the AP 130 in the database 250 and update the database 250 if the AP 130 is moved from one location to another. In another example implementation, the location server 145 may store the geospatial information of multiple Aps and update the database 250 when any of the multiple Aps is moved from one location to another. The geospatial information of multiple Aps, may, for example, be stored in the database 250 in the form of a coverage map.

In another example implementation, the location server 145 may utilize the geospatial information of multiple Aps stored in the database to locate one or more user devices when, for example, a user device communicatively attaches to a first AP and/or when the user device communicatively attaches to a first AP followed by communicatively attaching to a second AP when the user device moves from a first location at which the first AP is located to a second location at which the second AP is located. In an example embodiment, the movement of the user device can be a part of a tracking procedure to track the user device.

FIG. 9 illustrates an example database 900 that can include augmented location information pertaining to multiple Aps. One example of such a database can be the database 250 illustrated in FIG. 2 and described above. The example database 900 can include information pertaining to “n” Aps (n≥2). In some implementations, some of the information can be omitted and some other information (such as, for example, data associated with server-related interactions between the location server 145 and other devices) can be included. The tabular format shown in FIG. 9 is merely one example format for storing augmented location information in an example implementation. Other formats may be used in other implementations.

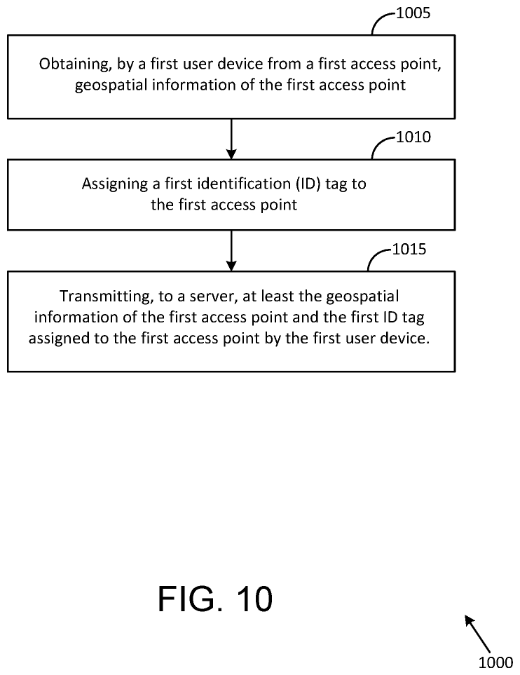

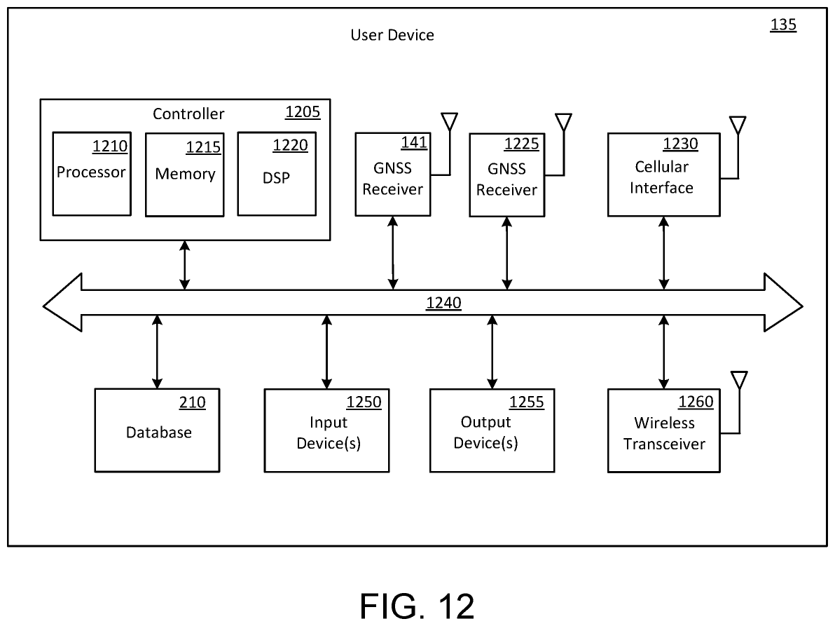

FIG. 10 shows a flowchart 1000 of a method performed by a first user device (such as, for example, user device 135) for providing location information to a server (such as, for example, the location server 145) in accordance with an embodiment of the disclosure. Means for performing the functionality illustrated in one or more of the blocks of the flowchart 1000 may be performed by hardware and/or software components of a user device such as, for example, a smartphone. In some examples, the user device may perform the functionality illustrated in one or more of the blocks shown in the flowchart 1000 in an operating environment such as illustrated in FIG. 2 and described above. Example components of a user equipment are illustrated in FIG. 12, which is described below.

At block 1005, the functionality can include obtaining, by the first user device from a first access point (such as, for example, AP 130), geospatial information of the first access point. In an example embodiment, the geospatial information of the first access point is obtained by the first user device from the first access point by using a location configuration information (LCI) format and/or a location civic report (LCR) format. Some details about a procedure that can be associated with this functionality are provided above with reference to FIGS. 3-7.

At block 1010, the functionality can include assigning a first identification (ID) tag to the first access point. As indicated above, the ID tag can be any label that is used to uniquely identify an access point such as, for example, the AP 130. One example of an ID tag can be a label such as, for example, a name assigned to the AP 130 by an individual associated with the AP 130 (user, manager, administrator, etc.) or a physical address in which the AP 130 is located (ABC company office, XYZ residence, etc.). Another example of an ID tag can be a wireless wide area network (WWAN) cell identification, an international mobile subscriber identity (IMSI) of the AP 130, an APN of the AP 130, or a MAC address of the AP 130.

At block 1015, the functionality can include transmitting, at least the geospatial information of the first access point and the first ID tag assigned to the first access point by the first user device. An example of this functionality is described above with reference to FIG. 2, where the user device 135 transmits to the location server 145, for inclusion in the database 250, information about the AP 130. The information can include, for example, a combination of location information of the user device 135 (GPS coordinates, map information, etc.), geospatial information of the AP 130, and an ID tag assigned by the user device 135 to the AP 130. The location information of the user device 135 can be generated by the user device 135 based on executing a location determination procedure that includes obtaining information from one or more of various sources (GNSS satellite vehicles, cellular communication towers, location information provider 160, short-range devices, etc.). In an example implementation, the server may include the geospatial information of the AP 130 and the ID tag assigned by the user device 135 to the AP 130, in a database containing information about one or more access points.

The method described above with reference to the flowchart 1000 can further include functionalities such as, for example, obtaining, by the first user device from a second access point, geospatial information of the second access point. The first user device may assign a second ID tag to the second access point and can transmit to the server, for inclusion in the database, at least the geospatial information of the second access point and the second ID tag assigned to the second access point by the first user device. In an example embodiment, the information about at least the first access point and the second access point can be used by the server to create a coverage map of access points in a geographical area. The coverage map can be stored in the database of the server.

In an example implementation, the server may subsequently receive, from a second user device, a request for information about the first access point and/or the second access point. The server may respond to the request by transmitting, to the second user device, at least a portion of the information contained in the database. In an example scenario, the server may respond to the request by transmitting the coverage map to the second user device.

In another example implementation, upon receiving the geospatial information of the second access point and the second ID tag, the server may update the database such as, for example, by adding to the database, the geospatial information of the second access point. Furthermore, the server may subsequently receive, from a second user device, a request for information about the first access point and/or the second access point. The server may respond to the request by transmitting, to the second user device, at least a portion of the information contained in the updated database. In an example scenario, the server may respond to the request by transmitting the coverage map to the second user device.

In another example implementation, the user device may receive, from the server, a query for location information of the first user device. The user device may generate location information of the first user device based on executing a location determination procedure in the manner described above, and transmit, to the server, location information of the first user device for use by the server to authenticate the geospatial information of the first access point.

In another example implementation, the user device may transmit to the server, the location information of the first user device without a query being received from the server. In this scenario, the location information of the first user device may be transmitted to the server along with the geospatial information of the AP and the ID tag assigned by the user device to the AP. Alternatively, the location information of the first user device may be transmitted to the server prior to, or after, transmitting the geospatial information of the AP and the ID tag assigned by the user device to the AP.

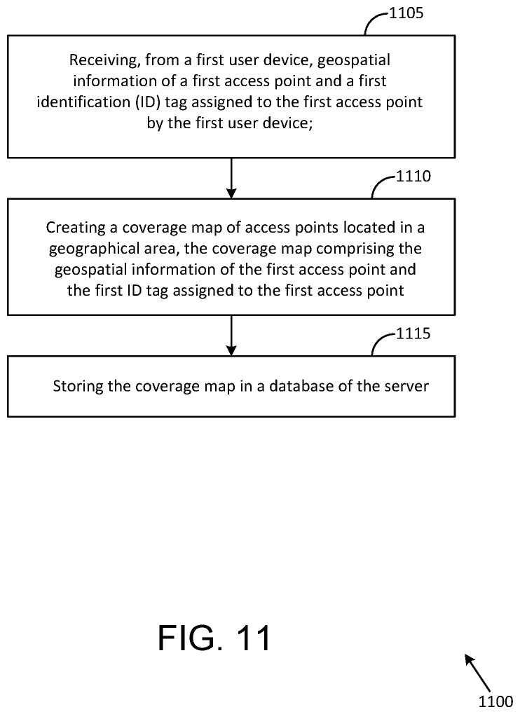

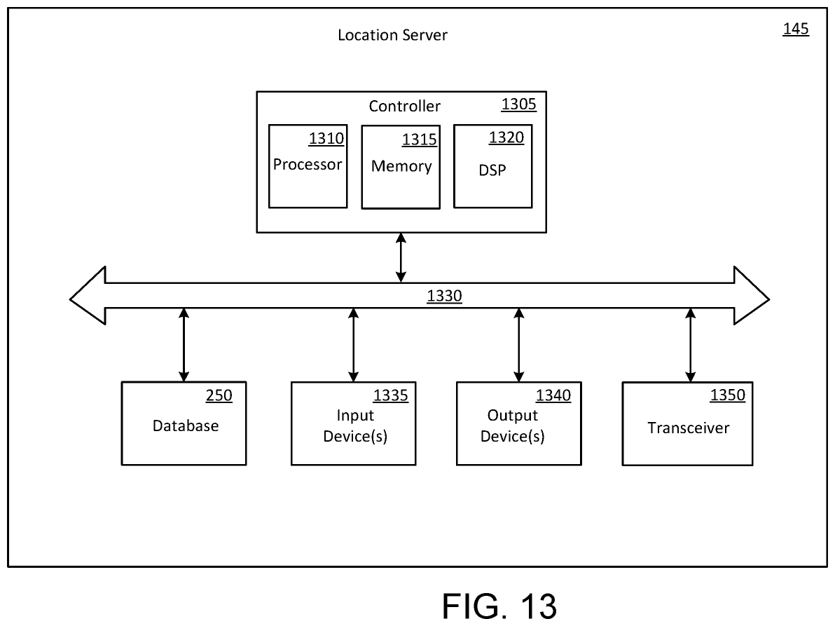

FIG. 11 shows a flowchart 1100 of a method performed by a server (such as, for example, location server 145) for determining user device location in accordance with an embodiment of the disclosure. Means for performing the functionality illustrated in one or more of the blocks of the flowchart 1100 may be performed by hardware and/or software components of a server such as, for example, the location server 145 described herein. In some examples, the server may perform the functionality illustrated in one or more of the blocks of the flowchart 1100 in an operating environment such as illustrated in FIG. 2 and described above. Example components of the location server 145 are illustrated in FIG. 13, which is described below.

At block 1105, the functionality can include receiving, from a first user device, geospatial information of a first access point and a first identification (ID) tag assigned to the first access point by the first user device. In an example embodiment, the geospatial information of the first access point is obtained by the first user device from the first access point by using a location configuration information (LCI) format and/or a location civic report (LCR) format. The user device may then convey the geospatial information to the server in the form of a location configuration information (LCI) report and/or a location civic report (LCR). Some details about a procedure that can be associated with this functionality are provided above with reference to FIGS. 3-7.

At block 1110, the functionality can involve creating a coverage map of access points located in a geographical area. The coverage map can include the geospatial information of the first access point and the first ID tag assigned to the first access point.

At block 1115, the functionality can include storing the coverage map in a database of the server.

The method described above with reference to the flowchart 1100 can further include functionalities such as, for example, transmitting, to the first user device, a request to provide location information of the first user device. The first user device (for example, the user device 135) may respond to the request by providing location information of the first user device. The location information of the user device can be generated by the user device based on executing a location determination procedure that includes obtaining information from one or more of various sources (GNSS satellite vehicles, cellular communication towers, location information provider 160, short-range devices, etc.). The server may then authenticate the geospatial information of the first access point based on the location information provided by the first user device. In an alternative scenario, server may receive from the user device, location information of the first user device without a query being transmitted by the server to the user device. The location information of the first user device may be received by the server prior to, along with, or after receiving the geospatial information of the AP and the ID tag assigned by the user device to the AP.

In an example implementation, the server may augment the location information received from the first user device with the geospatial information of the first access point and/or the first ID tag assigned by the first user device to the geospatial information of the first access point.

In an example implementation, the server may further receive, from a second user device, geospatial information of a third access point and a third ID tag assigned by the second user device to the third access point. The server may then update the coverage map of access points based on the geospatial information of the third access point and/or the second ID tag assigned to the third access point by the second user device. The coverage map, in part or in entirety, may be made available to one or more other user devices upon request.

FIG. 12 shows a block diagram of various hardware components of the user device 135 according to an embodiment. It should be noted that FIG. 12 is meant only to provide a generalized illustration of various components, any or all of which may be utilized as appropriate. The user device 135 may vary in form and function, and may ultimately comprise any device that can perform the functions described herein in accordance with disclosure. A non-exhaustive list of such devices can include, for example, a smartphone, a mobile phone, a tablet computer, a laptop computer, a wearable device (e.g., smartwatch, glasses, Augmented Reality (AR)/Virtual Reality (VR) headset, etc.), an Internet of Things (IoT) device, and survey equipment.

It must be understood that the user device 135 is shown as including various hardware components some of which may support operations of the location determination system 140 described above, some of which may support primary functions of the user device 135 (such as, for example, support cell phone communications when the user device 135 is a mobile phone), and some of which may support primary functions of the user device 135 as well as operations of the location determination system 140 described above. For example, when the user device 135 is a mobile phone, the cellular interface 1230 described below may support cellular communications of the mobile phone (voice calls, Internet access, etc.) and may also enable location determination operations (based, for example, on a multilateration procedure described above).

In this example, the various hardware components can be electrically coupled via a bus 1240 (or may otherwise be in communication, as appropriate) and may include one or more processors, such as, for example, one or more general-purpose processors, one or more special-purpose processors (such as DSP chips, graphics processors (GPUs), application specific integrated circuits (ASICs), and/or the like), and/or other processor, processing structure, processing unit, or processing means. An example processor 1210 is shown in FIG. 12. Some embodiments may have a separate DSP 1220, depending on desired functionality. Various operations in accordance with the disclosure may be performed by the processor 1210 in cooperation with various other components coupled to the bus 1240. The hardware components may also include one or more memories, such as, for example, the memory 1215. The processor 1210 can communicate with the memory 1215 and access software and/or firmware code stored in the memory 1215 for executing various operations in accordance with the disclosure. In the illustrated example implementation, the processor 1210, the memory 1215, and the DSP 1220 are components included in a controller 1205. The controller 1205 can include several other components that are not shown.

In the illustrated example embodiment, the user device 135 includes two GNSS receivers—the GNSS receiver 141 described above and another GNSS receiver 1225. In other embodiments, the user device 135 can include a single GNSS receiver or more than two GNSS receivers. In this example, the GNSS receiver 141 may be configured to receive a GNSS signal from the satellite vehicle 105 shown in FIG. 1. The GNSS receiver 1225 may be configured to receive a GNSS signal from a satellite vehicle other than the satellite vehicle 105, such as, for example, the satellite vehicle 110 shown in FIG. 1.

The user device 135 can further include a cellular interface 1230 and a wireless transceiver 1260. The cellular interface 1230 may be configured to support cellular communications functions of the user device 135 with the cellular network 138 described above and/or to enable location determination operations. In an example scenario, a location determination procedure to obtain location information of the user device 135 can involve a multilateration procedure based on communications with at least three cellular communication towers (such as, for example, the first cellular communication tower 115, the second cellular communication tower 120, and the third cellular communication tower 125 illustrated in FIG. 1).

The wireless transceiver 1260 may be configured to support communications between the user device 135 and the AP 130 in one or more of various communications formats such as, for example, WiFi, ultra-wide band (UWB), Bluetooth®, infrared, near field communication (NFC), ultraband and Zigbee®.

The user device 135 may further include the database 210 that can be configured to store information such as, for example, the information stored in the example database 900 shown in FIG. 9. In an example implementation, the database 210 can be a part of the memory 1215.

The user device 135 can further include one or more input devices 1250, which can include without limitation a keyboard, touch screen, a touch pad, microphone, button(s), dial(s), switch(es), and/or the like; and one or more output devices 1255, which can include without limitation a display, light emitting diode (LED), speakers, and/or the like. As will be appreciated, the type of input devices 1250 and output devices 1255 may depend on the type of user device 135 with which the input devices 1250 and output devices 1255 are integrated.

FIG. 13 shows a block diagram of various hardware components of the location server 145 according to an embodiment. It should be noted that FIG. 13 is meant only to provide a generalized illustration of various components, any or all of which may be utilized as appropriate. The location server 145 may vary in form and function, and may ultimately comprise any device that can perform the functions described herein in accordance with disclosure.

It must be understood that the location server 145 is shown as including various hardware components some of which may support operations of the location determination system 140 described above, some of which may support primary functions of the location server 145 (such as, for example, server-related functions), and some of which may support primary functions of the location server 145 as well as operations of the location determination system 140 described above.

In this example, the various hardware components can be electrically coupled via a bus 1330 (or may otherwise be in communication, as appropriate) and may include one or more processors, such as, for example, one or more general-purpose processors, one or more special-purpose processors (such as DSP chips, graphics processors (GPUs), application specific integrated circuits (ASICs), and/or the like), and/or other processor, processing structure, processing unit, or processing means. An example processor 1310 is shown in FIG. 13. Some embodiments may have a separate DSP 1320, depending on desired functionality. Various operations in accordance with the disclosure may be performed by the processor 1310 in cooperation with various other components coupled to the bus 1330. The hardware components may also include one or more memories, such as, for example, the memory 1315. The processor 1310 can communicate with the memory 1315 and access software and/or firmware code stored in the memory 1315 for executing various operations in accordance with the disclosure. In the illustrated example implementation, the processor 1310, the memory 1315, and the DSP 1320 are components included in a controller 1305. The controller 1305 can include several other components that are not shown.

The location server 145 may further include a communication interface 1350 that is configured to allow the location server 145 to communicate with elements such as, for example, the AMF 245 (shown in FIG. 2) and/or one or more devices via the network 165 (shown in FIG. 1).

The location server 145 may further include the database 250 described above. In an example implementation, the database 250 can be a part of the memory 1315.

The location server 145 can further include one or more input devices 1335, which can include without limitation a keyboard, touch screen, a touch pad, microphone, button(s), dial(s), switch(es), and/or the like; and one or more output devices 1340, which can include without limitation a display, light emitting diode (LED), speakers, and/or the like. As will be appreciated, the type of input devices 1335 and output devices 1340 may depend on the type of location server 145 with which the input devices 1335 and output devices 1340 are integrated.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1 A method executed by a first user device to provide access point information can include obtaining, by the first user device from a first access point, geospatial information of the first access point; assigning a first identification (ID) tag to the first access point; and transmitting, to a server, at least the geospatial information of the first access point and the first ID tag assigned to the first access point by the first user device.
Clause 2 The method of clause 1, wherein the at least the geospatial information of the first access point and the first ID tag assigned to the first access point is transmitted to the server for inclusion in a database containing information about one or more access points, and wherein the method further comprises: include obtaining, by the first user device from a second access point, geospatial information of the second access point; assigning a second ID tag to the second access point; and transmitting, to the server, for inclusion in the database, at least the geospatial information of the second access point and the second ID tag assigned to the second access point by the first user device.
Clause 3 The method of clause 2, further comprising creating a coverage map based on at least the information about at least the first access point and the second access point; and storing the coverage map in the database.
Clause 4 The method of either clause 2 or clause 3, can further include receiving, from a second user device, a request for information about at least one of the first access point or the second access point; and transmitting, to the second user device, at least a portion of the coverage map stored in the second database.
Clause 5 The method of clause 4, wherein the at least the portion of the coverage map is transmitted by the first user device to the second user device as a part of a sidelink procedure.
Clause 6 The method of any of clauses 1-5, wherein the geospatial information of the first access point is obtained by the first user device from the first access point by using at least one of a location configuration information (LCI) format or a location civic report (LCR) format.
Clause 7 The method of clause 1, can further include generating location information of the first user device based on executing a location determination procedure; and transmitting, to the server, location information of the first user device for use by the server to authenticate the geospatial information of the first access point.
Clause 8 The method of any of clauses 1-7, wherein the first ID tag is based on at least one of a wireless wide area network cell identification of the first access point or a media access control (MAC) address of the first access point, and wherein the location determination procedure is based on at least one of Global Navigation Satellite Systems (GNSS) signals received from one or more GNSS satellite vehicles, cellular signals received from a cellular network, information received from a location information provider, or communications with another user device using a sidelink positioning protocol (SLPP).
Clause 9 A method executed by a server to offer access point information can include receiving, from a first user device, geospatial information of a first access point and a first identification (ID) tag assigned to the first access point by the first user device; creating a coverage map of access points located in a geographical area, the coverage map comprising the geospatial information of the first access point and the first ID tag assigned to the first access point; and storing the coverage map in a database of the server.
Clause 10 The method of clause 9, wherein the geospatial information of the first access point that is provided by the first user device comprises at least one of location configuration information (LCI) report or a location civic report (LCR).
Clause 11 The method of either clause 9 or 10, can further include receiving, from the first user device, location information of the first user device; and authenticating the geospatial information of the first access point based on the location information of the first user device.
Clause 12 The method of any of clauses 9-11, can further include augmenting the location information received from the first user device with the geospatial information of the first access point and/or the first ID tag assigned by the first user device to the geospatial information of the first access point.
Clause 13 The method of any of clauses 9-12, can further include receiving, from the first user device, geospatial information of a second access point and a second ID tag assigned by the first user device to the second access point; and updating the coverage map of access points based on at least one of the geospatial information of the second access point or the second ID tag assigned to the second access point.
Clause 14 The method of clause 13 can further include receiving, from a second user device, geospatial information of a third access point and a third ID tag assigned by the second user device to the third access point; and updating the coverage map of access points based on at least one of the geospatial information of the third access point or the second ID tag assigned to the third access point.
Clause 15 The method of clause 14, wherein the third access point is one of the first access point or the second access point.
Clause 16 The method of clause 14 can further include receiving, from a third user device, a request for the coverage map; and transmitting, to the third user device, at least a part of the coverage map.
Clause 17 A user device that provides access point information can include at least one transceiver and a location determination system. The location determination system can include at least one memory; and one or more processors communicatively coupled with the at least one memory, the one or more processors configured to obtain from a first access point, via the at least one transceiver, geospatial information of the first access point; assign a first identification (ID) tag to the first access point; and transmit to a server, via the at least one transceiver, at least the geospatial information of the first access point and the first ID tag assigned to the first access point by the one or more processors of the user device
Clause 18 The user device of clause 17, wherein the at least the geospatial information of the first access point and the first ID tag assigned to the first access point is transmitted to the server for inclusion in a database containing information about one or more access points, and wherein the one or more processors are further configured to obtain from a second access point, via the at least one transceiver, geospatial information of the second access point; assign a second ID tag to the second access point; and transmit, to the server, via the at least one transceiver, for inclusion in the database, at least the geospatial information of the second access point and the second ID tag assigned to the second access point by the one or more processors of the user device.
Clause 19 The user device of clause 18, wherein the information about the one or more access points is provided in the form of a coverage map of access points in a geographical area.
Clause 20 The user device of either clause 18 or clause 19, wherein the one or more processors are further configured to receive from another user device, via the at least one transceiver, a request for information about at least one of the first access point or the second access point; and transmit to the another user device, via the at least one transceiver, at least a portion of the coverage map.
Clause 21 The user device of clause 20, wherein the at least the portion of the coverage map is transmitted by the user device to the another user device as a part of a sidelink procedure.
Clause 22 The user device of any of clauses 17-21, wherein the geospatial information of the first access point is obtained by the user device from the first access point by using at least one of a location configuration information (LCI) format or a location civic report (LCR) format.
Clause 23 The user device of any of clauses 17-22, wherein the one or more processors are further configured to generate location information of the user device based on executing a location determination procedure; and transmit to the server, via the at least one transceiver, location information of the user device for use by the server to authenticate the geospatial information of the first access point.
Clause 24 The user device of any of clauses 17-23, wherein the first ID tag is based at least in part on at least one of a wireless wide area network cell identification of the first access point or a media access control (MAC) address of the first access point, and wherein the location determination procedure is based on at least one of Global Navigation Satellite Systems (GNSS) signals received from one or more GNSS satellite vehicles, cellular signals received from a cellular network, information received from a location information provider, or communications with another user device using a sidelink positioning protocol (SLPP).
Clause 25 A server that provides access point information can include at least one transceiver and a location determination system. The location determination system can include at least one memory; and one or more processors communicatively coupled with the at least one memory, the one or more processors configured to receive from a first user device, via the at least one transceiver, geospatial information of a first access point and a first identification (ID) tag assigned to the first access point by the first user device; create a coverage map of access points located in a geographical area, the coverage map comprising the geospatial information of the first access point and the first ID tag assigned to the first access point; and store the coverage map in a database of the server.
Clause 26 The server of clause 25, wherein the geospatial information of the first access point that is provided by the first user device comprises at least one of location configuration information (LCI) report or a location civic report (LCR).
Clause 27 The server of either clause 25 or clause 26, wherein the one or more processors are further configured to receive from the first user device, via the at least one transceiver, a response to the request, the response comprising location information of the first user device; and authenticate the geospatial information of the first access point based on the location information of the first user device.
Clause 28 The server of any of clauses 25-27, wherein the one or more processors are further configured to augment the location information received from the first user device with the geospatial information of the first access point and/or the first ID tag assigned by the first user device to the geospatial information of the first access point.
Clause 29 The server of any of clauses 25-28, wherein the one or more processors are further configured to receive from the first user device, via the at least one transceiver, geospatial information of a second access point and a second ID tag assigned by the first user device to the second access point; and update the coverage map of access points based on at least one of the geospatial information of the second access point or the second ID tag assigned to the second access point.
Clause 30 The server of clause 29, wherein the one or more processors are further configured to receive from a second user device, via the at least one transceiver, geospatial information of a third access point and a third ID tag assigned by the second user device to the third access point; and update the coverage map of access points based on at least one of the geospatial information of the third access point or the second ID tag assigned to the third access point.
Clause 31 An apparatus having means for performing the method of any of clauses 1-8.
Clause 32 An apparatus having means for performing the method of any of clauses 9-16.
Clause 33 A non-transitory computer-readable medium storing instructions, the instructions comprising code for performing the method of any of clauses 1-8.
Clause 34 A non-transitory computer-readable medium storing instructions, the instructions comprising code for performing the method of any of clauses 9-16.

What is claimed is:

1. A method executed by a first user device to provide access point information, the method comprising:
obtaining, by the first user device from a first access point, geospatial information of the first access point;
assigning a first identification (ID) tag to the first access point; and
transmitting, to a server, at least the geospatial information of the first access point and the first ID tag assigned to the first access point by the first user device.

2. The method of claim 1, wherein the at least the geospatial information of the first access point and the first ID tag assigned to the first access point is transmitted to the server for inclusion in a database containing information about one or more access points, and wherein the method further comprises:
obtaining, by the first user device from a second access point, geospatial information of the second access point;
assigning a second ID tag to the second access point; and
transmitting, to the server, for inclusion in the database, at least the geospatial information of the second access point and the second ID tag assigned to the second access point by the first user device.

3. The method of claim 2, further comprising:
creating a coverage map based on at least the information about the first access point and the second access point; and
storing the coverage map in the database.

4. The method of claim 3, further comprising:
receiving, from a second user device, a request for information about at least one of the first access point or the second access point; and
transmitting, to the second user device, at least a portion of the coverage map stored in the database.

5. The method of claim 4, wherein the at least the portion of the coverage map is transmitted by the first user device to the second user device as a part of a sidelink procedure.

6. The method of claim 1, wherein the geospatial information of the first access point is obtained by the first user device from the first access point by using at least one of a location configuration information (LCI) format or a location civic report (LCR) format.

7. The method of claim 1, further comprising:
generating location information of the first user device based on executing a location determination procedure; and
transmitting, to the server, location information of the first user device for use by the server to authenticate the geospatial information of the first access point.

8. The method of claim 7, wherein the first ID tag is based at least in part on at least one of a wireless wide area network cell identification of the first access point or a media access control (MAC) address of the first access point, and wherein the location determination procedure is based on at least one of Global Navigation Satellite Systems (GNSS) signals received from one or more GNSS satellite vehicles, cellular signals received from a cellular network, information received from a location information provider, communications with a short-range device, or communications with another user device using a sidelink positioning protocol (SLPP).

9. A method executed by a server to offer access point information, the method comprising:
receiving, from a first user device, geospatial information of a first access point and a first identification (ID) tag assigned to the first access point by the first user device;
creating a coverage map of access points located in a geographical area, the coverage map comprising the geospatial information of the first access point and the first ID tag assigned to the first access point; and
storing the coverage map in a database of the server.

10. The method of claim 9, wherein the geospatial information of the first access point that is provided by the first user device comprises at least one of a location configuration information (LCI) report or a location civic report (LCR).

11. The method of claim 9, further comprising:
receiving, from the first user device, location information of the first user device; and
authenticating the geospatial information of the first access point based on the location information of the first user device.

12. The method of claim 11, further comprising:
augmenting the location information received from the first user device with the geospatial information of the first access point and/or the first ID tag assigned by the first user device to the geospatial information of the first access point.

13. The method of claim 9, further comprising:
receiving, from the first user device, geospatial information of a second access point and a second ID tag assigned by the first user device to the second access point; and
updating the coverage map of access points based on at least one of the geospatial information of the second access point or the second ID tag assigned to the second access point.

14. The method of claim 13, further comprising:
receiving, from a second user device, geospatial information of a third access point and a third ID tag assigned by the second user device to the third access point; and
updating the coverage map of access points based on at least one of the geospatial information of the third access point or the second ID tag assigned to the third access point.

15. The method of claim 14, wherein the third access point is one of the first access point or the second access point.

16. The method of claim 14, further comprising:
receiving, from a third user device, a request for the coverage map; and
transmitting, to the third user device, at least a part of the coverage map.

17. A user device that provides access point information, comprising:
at least one transceiver; and
a location determination system comprising:
at least one memory; and
one or more processors communicatively coupled with the at least one memory, the one or more processors configured to:
obtain from a first access point, via the at least one transceiver, geospatial information of the first access point;
assign a first identification (ID) tag to the first access point; and
transmit to a server, via the at least one transceiver, at least the geospatial information of the first access point and the first ID tag assigned to the first access point by the one or more processors of the user device.

18. The user device of claim 17, wherein the at least the geospatial information of the first access point and the first ID tag assigned to the first access point is transmitted to the server for inclusion in a database containing information about one or more access points, and wherein the one or more processors are further configured to:
obtain from a second access point, via the at least one transceiver, geospatial information of the second access point;
assign a second ID tag to the second access point; and
transmit, to the server, via the at least one transceiver, for inclusion in the database, at least the geospatial information of the second access point and the second ID tag assigned to the second access point by the one or more processors of the user device.

19. The user device of claim 18, wherein the information about the one or more access points is provided in the form of a coverage map of access points in a geographical area.

20. The user device of claim 19, wherein the one or more processors are further configured to:
receive from another user device, via the at least one transceiver, a request for information about at least one of the first access point or the second access point; and
transmit to the another user device, via the at least one transceiver, at least a portion of the coverage map.

21. The user device of claim 20, wherein the at least the portion of the coverage map is transmitted by the user device to the another user device as a part of a sidelink procedure.

22. The user device of claim 17, wherein the geospatial information of the first access point is obtained by the user device from the first access point by using at least one of a location configuration information (LCI) format or a location civic report (LCR) format.

23. The user device of claim 17, wherein the one or more processors are further configured to:
generate location information of the user device based on executing a location determination procedure; and
transmit to the server, via the at least one transceiver, location information of the user device for use by the server to authenticate the geospatial information of the first access point.

24. The user device of claim 23, wherein the first ID tag is based at least in part on at least one of a wireless wide area network cell identification of the first access point or a media access control (MAC) address of the first access point, and wherein the location determination procedure is based on at least one of Global Navigation Satellite Systems (GNSS) signals received from one or more GNSS satellite vehicles, cellular signals received from a cellular network, information received from a location information provider, or communications with another user device using a sidelink positioning protocol (SLPP).

25. A server that provides access point information, comprising:
at least one transceiver; and
a location determination system comprising:
at least one memory; and
one or more processors communicatively coupled with the at least one memory, the one or more processors configured to:
receive from a first user device, via the at least one transceiver, geospatial information of a first access point and a first identification (ID) tag assigned to the first access point by the first user device;
create a coverage map of access points located in a geographical area, the coverage map comprising the geospatial information of the first access point and the first ID tag assigned to the first access point; and
store the coverage map in a database of the server.

26. The server of claim 25, wherein the geospatial information of the first access point that is provided by the first user device comprises at least one of location configuration information (LCI) report or a location civic report (LCR).

27. The server of claim 25, wherein the one or more processors are further configured to:
receive from the first user device, via the at least one transceiver, location information of the first user device; and
authenticate the geospatial information of the first access point based on the location information of the first user device.

28. The server of claim 27, wherein the one or more processors are further configured to:
augment the location information received from the first user device with the geospatial information of the first access point and/or the first ID tag assigned by the first user device to the geospatial information of the first access point.

29. The server of claim 25, wherein the one or more processors are further configured to:
receive from the first user device, via the at least one transceiver, geospatial information of a second access point and a second ID tag assigned by the first user device to the second access point; and
update the coverage map of access points based on at least one of the geospatial information of the second access point or the second ID tag assigned to the second access point.

30. The server of claim 29, wherein the one or more processors are further configured to:
receive from a second user device, via the at least one transceiver, geospatial information of a third access point and a third ID tag assigned by the second user device to the third access point; and
update the coverage map of access points based on at least one of the geospatial information of the third access point or the second ID tag assigned to the third access point.
